(19) United States
(12) Patent Application Publication
(10) Pub. No.: US 2007/0159826 A1
(43) Pub. Date: Jul. 12, 2007

(54) Adapter set for fluorescent tubes

(76) Inventors: Li Donglin, Zhongshan City (CN); Xie Fufu, Zhongshan City (CN); Zhang Dinglv, Zhongshan City (CN); Chuk Leung Yuen, Hong Kong (CN)

Correspondence Address: MICHAEL L. DIAZ, P.C., 555 REPUBLIC DRIVE, SUITE 200, PIANO, TX, 75074, US

(21) Appl. No.: 11/328,637

(22) Filed: Jan. 10, 2006

(51) Int. Cl. F21V 23/02

(52) U.S. Cl. 362/260

(57) ABSTRACT

The present invention discloses an adapter set for fluorescent tubes, which comprises a holder to match the length of T8/T10 fluorescent tubes, two sockets mounted on both ends of said holder, wherein each of the two sockets further comprises a adaptor respectively, each adaptor is adapted to connect with a socket at one end, and provides an outlet for a T5/T4 fluorescent tube at the other end. The adaptors can be easily removed from the sockets. The present invention will provide a simple and easy replacement of the T8/T10 tube as well as also enable recycling of the parts and provide for a better working environment.

### BACKGROUND OF THE INVENTION

1. Field of the Invention

The present invention relates to lighting systems, and more especially to a bracket with an electronic circuitry for fluorescent tubes.

2. Description of the Related Art

A conventional bracket that holds a conventional fluorescent tube is built in as part of the fluorescent tube batten. It consists of two sockets which are mounted on both ends of the batten. The sockets are attached on the holders at both ends of the batten with the distance between the holders being fixed for T8/T10 fluorescent tubes. T5/T4 fluorescent tubes are now being introduced into the marketplace to replace T8/T10 tubes. However, the conventional batten is incapable of adapting or accommodating a T5 or T4 fluorescent tube.

### SUMMARY OF THE INVENTION

The object of this invention is to provide an adapter set for T5/T4 fluorescent tubes which are being used to replace conventional T8/T10 fluorescent tubes. The adapter set for the fluorescent tubes of this invention includes a holder and two sockets which are mounted on both ends of the holder for a T8 fluorescent tube or above, wherein each of the two sockets further comprises an adapter on each end. The adaptors are each connected with a T5 fluorescent tube or same length tube at both ends, and replace the existing T8 fluorescent tube or same length tube.

In the present invention, the adaptors act as to extend the sockets, shorten the distance of the two sockets, and make the bracket of a T8/T10 tube match the T5/T4 fluorescent tube. Additionally, the adapters are built in with an electronic circuitry to work with T5/T4 tubes as well as for the replacement of T8/T10 tube. The invention includes the electronic circuitry for T5/T4 tube to yield better performances than the conventional T8/T10 tube in terms of, light intensity output, efficiency, power factor, third harmonic distortion, comfort for eyes and environmental betterment.

These and other objects, advantages and novel features of the present invention will become more apparent from the following detailed description when taken in conjunction with the accompanying drawings.

### BRIEF DESCRIPTION OF THE DRAWINGS

The design and manner of the structure and operation of the invention, together with objects and advantages thereof, may best be understood by reference to the following description, taken in connection with the accompanying drawings, wherein like reference numerals identify like elements in which:

FIG. 1 is a front view of an adapter set for fluorescent tubes of the present invention;

FIG. 2 is a solid exploded view of the adapter set for fluorescent tubes of the present invention; and

FIG. 3 is a structural view of the adapter set for fluorescent tubes of the present invention.

### DESCRIPTION OF THE INVENTION

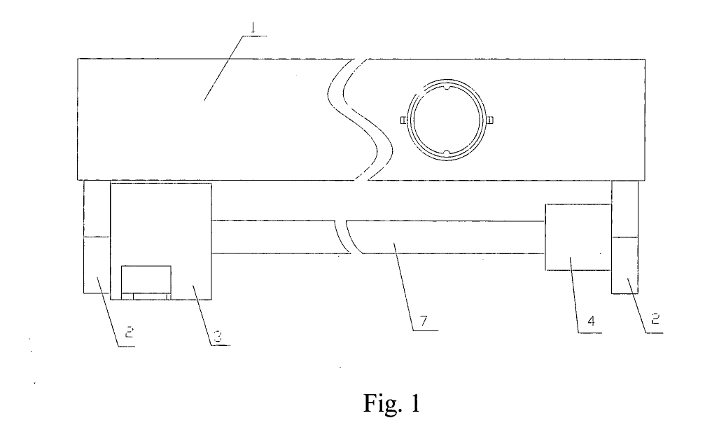

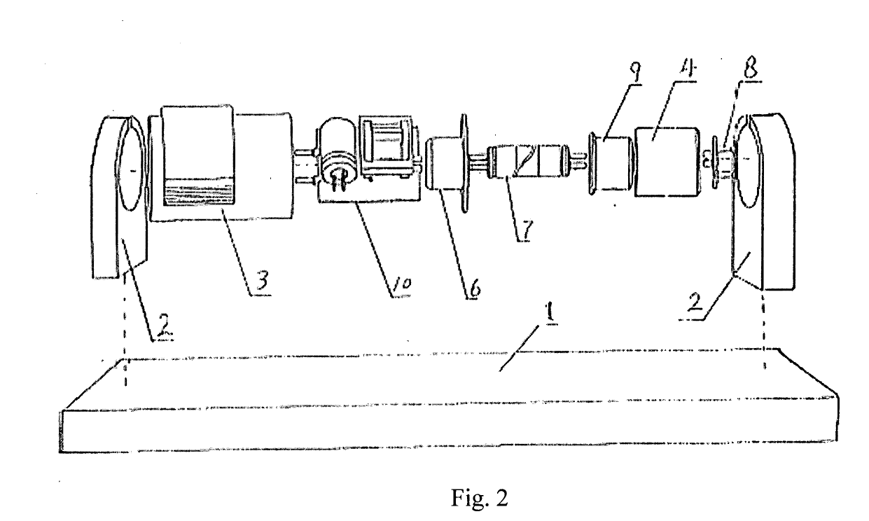

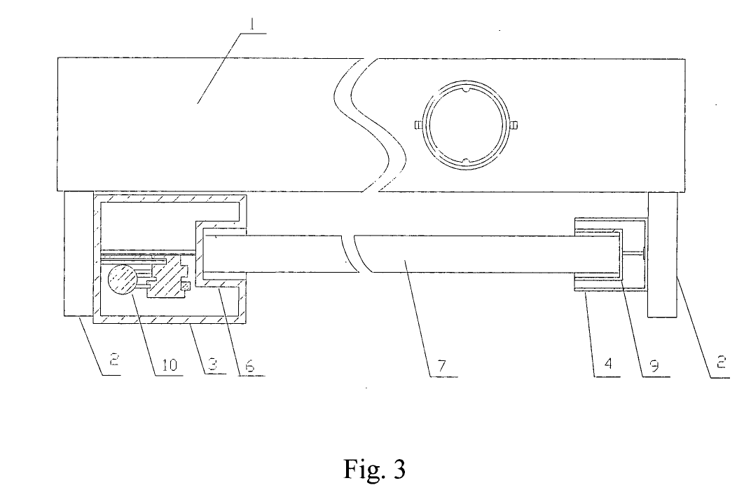

As shown in FIGS. 1-3, a holder 1 and two sockets 2 mounted on both ends of a holder 1 are located on the bracket of a T5/T4 fluorescent tube. Electronic circuitry adapting the T5/T4 fluorescent tube is mounted inside the holder 1. Adaptor 3 and adaptor 4 are installed respectively on the sockets 2 and can be easily taken down from sockets 2. One end of the adaptor 3 has a plug to insert into the left socket, while the other end of the adaptor 3 has a jack 6 to be inserted into the fluorescent tube 7. In addition, one end of the adaptor 4 has a plug 8 to insert into the right socket. The opposite end of the adaptor 4 has a jack 9 to be inserted into the fluorescent tube 7.

The adaptors 3 and 4 act to extend the sockets 2, shorten the distance of the two sockets, and make the bracket match the T5/T4 fluorescent tube. Electronic circuitry or elements 10 adapting to T5/T4 fluorescent tube may be mounted inside the adaptors, which enables the T5/T4 fluorescent tube work. The bracket/adapter of the present invention may be added on the T5/T4 tube to directly replace T8/T10 fluorescent tube together with replacing the starter with a protector as part of the adapter set.

While the present invention has been described with reference to certain embodiments, it will be understood by those skilled in the art that various changes may be made and equivalents may be substituted without departing from the scope of the present invention. In addition, many modifications may be made to adapt a particular situation or material to the teaching of the present invention without departing from its scope. Therefore, it is intended that the present invention not be limited to the particular embodiment disclosed, but that the present invention will include all embodiments falling within the scope of the appended claims.

What is claimed is:

1. An adapter set for fluorescent tubes, the adapter set comprising:
a holder to match the length of T8/T10 fluorescent tubes;
two sockets mounted on both ends of said holder, wherein each of the two sockets include an adapter to connect with a socket at one end, thereby providing an outlet for a T5/T4 fluorescent tube at an opposite end, said adaptors being removable from said sockets.

2. An adapter for a bracket for fluorescent tubes, the adapter comprising:
an adapter being connected with a socket at a first end;
the adapter providing an outlet for a T5/T4 fluorescent tube at a second opposite end, said adaptor being easily removable from said socket.
